(19) United States
(12) Patent Application Publication
(10) Pub. No.: US 2005/0257540 A1
(43) Pub. Date: Nov. 24, 2005

(54) Air conditioning system and method for controlling the same

(75) Inventors: Ho Seon Choi, Seoul (KR); Kwan Ho Yum, Seoul (KR); Ju Youn Lee, Seoul (KR)

Correspondence Address: BIRCH STEWART KOLASCH & BIRCH, PO BOX 747, FALLS CHURCH, VA, 22040-0747, US

(73) Assignee: LG Electronics Inc.

(21) Appl. No.: 11/048,740

(22) Filed: Feb. 3, 2005

(30) Foreign Application Priority Data
May 21, 2004 (KR) P2004-36351

(51) Int. Cl. G05D 23/00; F25D 17/00; F25D 15/00; F25D 23/12

(52) U.S. Cl. 62/180; 62/331; 236/51

(57) ABSTRACT

Air conditioning system including a temperature sensor for sensing a room temperature, an MET (metabolic) sensor for sensing an activity amount of people in a room, a dust sensor for sensing a dust amount, a gas sensor for sensing an intensity of smell, a VOC (Volatile Organic Compounds) sensor for sensing a compound amount, a fan driving unit for controlling an air flow rate, a heater for raising a room temperature, an anion generating unit for generating anion, and a control unit for controlling the fan driving unit and the heater according to an operation condition preset with reference to a sensed room temperature and the activity amount of people in the room, and controlling the fan driving unit and the anion generating unit according to an operation condition preset with reference to a sensed dust amount, the intensity of smell, and the VOC amount, thereby enhancing comfortability, and performing effective cleaning function, and displaying room cleanliness in real time on a screen, to improve a product reliability.

### CROSS-REFERENCE TO RELATED APPLICATION

This application claims the benefit of Korean Application No. P2004-0036351 filed on May 21, 2004, which is hereby incorporated by reference as if fully set forth herein.

### BACKGROUND OF THE INVENTION

1. Field of the Invention

The present invention relates to air conditioning systems, and more particularly, to an air conditioning system and a method for controlling the same.

2. Discussion of the Related Art

Most of modem people pass around 80% of their time in room spaces, such as homes, offices, or underground spaces. To the modem people who pass around 80% of their time in room spaces, a comfortable room environment becomes very important factor for enhancing efficiency of work, and maintaining their health. Especially, as living standards of the people becomes the higher, demands for the comfortable room space become the higher.

However, air in an enclosed space becomes to cause uncomfortable feeling as a carbon dioxide content increases by respiration of people in the room, and a heat load of the office increases rapidly due to office automation, and concentration coming from land price rise.

In order to solve the problem of uncomfortable feeling, and to provide a more comfortable environment to the people in the office, an air conditioning system is used, for controlling a temperature, a humidity, and so on of the office.

However, there has been a limitation in effective control of the air conditioning system, taking correlation between physical factors, such as a temperature, humidity, an air flow speed, and a radiation of the office, and the human heat senses into account.

According to this, there have been many indices of the human heat sense for quantitative expression of influences of various factors of the human heat sense to a human body, and suggesting a simple, and accurate comfortable range of the human heat sense.

Particularly, of the indices, the New Effective Temperature (ET) used in the USA, of the ASHRAE (American Society of Heating, Refrigerating, and Air-Conditioning Engineers), and the Predicted Mean Vote (PMV), and the Predicted Percentage of Dissatisfied (PPD) adopted as ISO (the International Organization for Standardization) 7730, used in Europe are typical indices for the human heat sense.

The PMV is an index for predicting the human heat sense theoretically by measuring 6 factors of the human heat sense of a human being, and an environment, i.e., an air temperature, a humidity, an air flow speed, a mean radiation temperature, an amount of clothes people put on, and an amount of activity, and substituting measured values for a comfort equation. The equation is expressed as follows.
PMV=(0.303Se^{-0.036sM}+0.028)S[(S−W)−H−E_{C}−Cᵣₑₛ−Eᵣₑₛ] (1)

Where, C denotes an air temperature, H denotes humidity, W denotes an air flow speed, E denote a average radiation temperature, C denotes an amount of clothes people put on, and M denotes an amount of activity

The PPD sets up scales of the human heat sense according to the PMV, such as “hot”, “warm”, “slightly warm”, “neutral (0)”, “slightly cool”, “cool”, “cold”, and so on, and represents a predicted percentage of dissatisfied persons for the present environment with the scale of the human heat sense.

Accordingly, once the PMW is determined with the equation 1, the PPD can be represent with the following equation (2).
PPP=100−95Se^{-(0.03353sPMV}^{⁴}^{+0.2179sPMV}^{²}⁾ (2)

If the room temperature and humidity meet the PPD calculated thus, a comfortable environment can be provided to the people in the room.

However, the related art air conditioning system has the following problems.

First, because the related art air conditioning system is operative only on the room temperature and the humidity, the sense of comfort the user required can not be met.

Second, the related art air conditioning system, not only can not deal with VOC, dust, and smell in the room which impede the sense of comfort appropriately, but also can not deal with correlation of above appropriately.

Third, even though heating of the room air is required for dust collection and sterilization, most of the related art air conditioning system are not provided with heaters, and even if provided, the heater is provided for simple room air heating, but not controlling the heater according to a room environment.

Fourth, even though the user desires to know a cleanliness of the present room air from the air conditioning system, because the related art air conditioning system can not calculate the room cleanliness, the user can not know the cleanliness.

### SUMMARY OF THE INVENTION

Accordingly, the present invention is directed to an air conditioning system and a method for controlling the same that substantially obviates one or more problems due to limitations and disadvantages of the related art.

An object of the present invention is to provide an air conditioning system and a method for controlling the same, which can provide an optimal sense of comfort to a user, always.

Another object of the present invention is to provide an air conditioning system and a method for controlling the same, in which air conditioning operation conditions and a heater operation condition are correlated, for enhancing user's satisfaction.

Another object of the present invention is to provide an air conditioning system and a method for controlling the same, which can show cleanliness of room air following operation of the air conditioning system.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, the Air conditioning system includes a temperature sensor for sensing a room temperature, an MET (metabolic) sensor for sensing an activity amount of people in a room, a dust sensor for sensing a dust amount, a gas sensor for sensing an intensity of smell, a VOC sensor for sensing a compound amount, a fan driving unit for controlling an air flow rate, a heater for raising a room temperature, an anion generating unit for generating anion, and a control unit for controlling the fan driving unit and the heater according to an operation condition preset with reference to a sensed room temperature and the activity amount of people in the room, and controlling the fan driving unit and the anion generating unit according to an operation condition preset with reference to a sensed dust amount, the intensity of smell, and the VOC amount.

In another aspect of the present invention, a method for controlling an air conditioning system includes the steps of sensing a room temperature, an activity amount of people in a room, a smell intensity, a dust amount, and a VOC amount, controlling an air flow rate of an air conditioning fan, and a temperature according to an operation condition preset with reference the sensed room temperature, and the activity amount of the people in the room, determining levels of smell, dust, and VOC with reference to the sensed smell intensity, the dust amount, and the VOC amount, and controlling the air flow rate of the air conditioning fan, and generation of anion according to an operation condition preset with reference to the levels determined in above step.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings;

FIG. 1 illustrates a block diagram of an air conditioning system in accordance with a preferred embodiment of the present invention;

FIG. 2 illustrates a flow chart showing the steps of a method for controlling a PMV of an air conditioning system in accordance with a preferred embodiment of the present invention;

FIG. 3 illustrates a table showing flow rate, and heater control methods according to a temperature and activity in FIG. 2;

FIG. 4 illustrates a flow chart showing a method for controlling air cleaning of an air conditioning system in accordance with a preferred embodiment of the present invention;

FIG. 5 illustrates a table for defining weighted values of amounts of dust, smell, and VOC in FIG. 4; and

FIG. 6 illustrates a table for defining air flow rate, and anion control methods according to dust, smell, and VOC level in FIG. 4.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

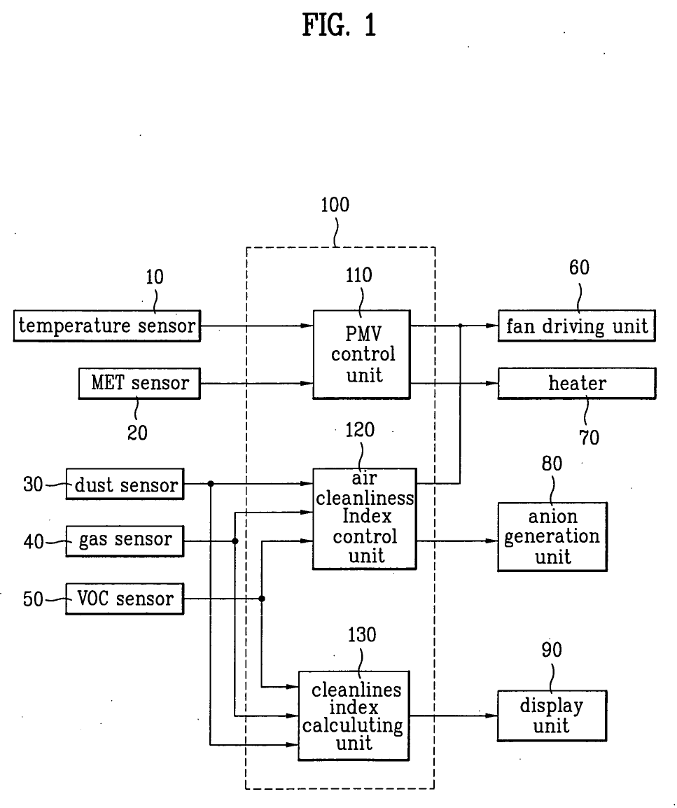

An air conditioning system in accordance with a first preferred embodiment of the present invention will be described with reference to FIG. 1.

Referring to FIG. 1, the air conditioning system includes a temperature sensor 10 for sensing a room temperature, a MET (metabolic) sensor for sensing activities of a person in a room, a dust sensor 30 for sensing an amount of dust, a gas sensor for sensing an amount of smell, a VOC (Volatile Organic Compounds) sensor 50 for sensing an amount of compounds, a fan driving unit 60 for controlling an air flow rate, a heater 70 for heating room air, an anion generating unit 80 for generating anions, a control unit 100 for controlling the fan driving unit 60 and the heater 70 according to an operation condition preset for the room temperature and the activity of the person in the room, and controlling the fan driving unit 60 and the anion generating unit 80 according to an operation condition preset for the amount of dust, amount of smell, and a VOC amount, and a display unit 90.

The VOC is a word collectively calling materials that make photochemical reaction by action of sunshine to produce photochemical oxidative material, such as ozone, PAN (peroxy-acetyl-nitrate), and so on if the materials co-exist with nitrogen oxides, to induce photochemical smog. The VOC is air pollutant, carcinogenic poisonous compound, and a causative agent of global warming, and destruction of a stratosphere of ozone sphere, and has offensive smell.

As the heater 70, a PTC (Positive Temperature Coefficient) heater may be used.

The control unit 100 includes a PMV control unit 110 for controlling the fan driving unit 60 and the heater 70 according to operation conditions preset according to outputs of the temperature sensor 10 and the MET sensor 20, an air cleaning control unit 120 for controlling the fan driving unit 60, and the anion generating unit 80 according to operation conditions preset according to outputs of the gas sensor 40, and the VOC sensor 50, and a cleanliness index calculation unit 130 for calculating an air cleanliness index with reference to outputs of the dust sensor 30, the gas sensor 40, and the VOC sensor 50.

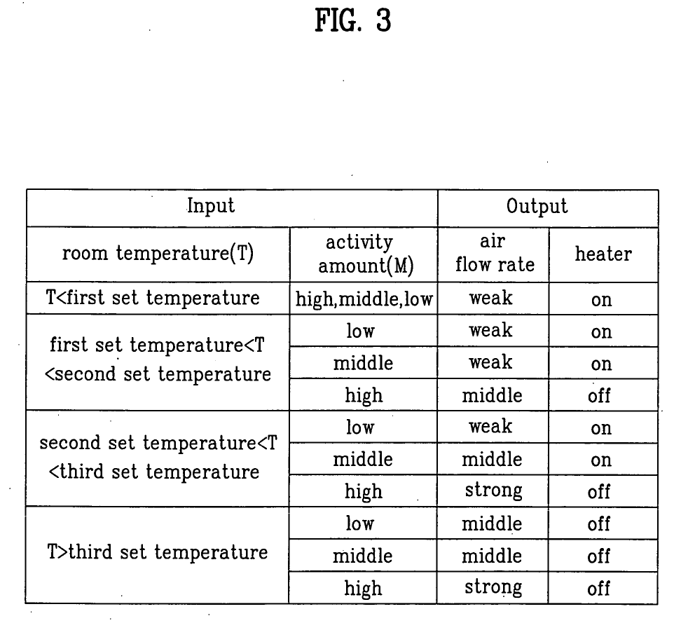

The PMV control unit 110 controls the PMV with reference to a temperature and activities, and has a lookup table therein, on which operation conditions are defined with reference to outputs of the temperature sensor 10 and the MET sensor 20. As shown in FIG. 3, in the lookup table, temperature ranges are defined with at least two set temperatures (a first to third set temperatures), and an activity level is defined as high, middle, and low for each of the temperature ranges, and the air flow rate and the heater operation condition are defined for each of the activity levels.

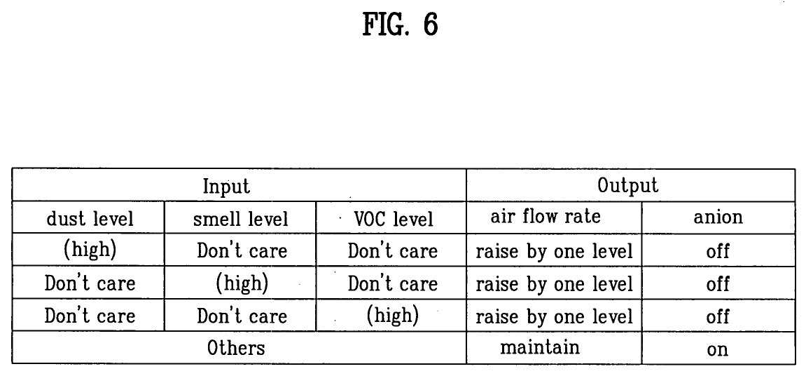

The air cleanliness control unit 120 has a lookup table therein having operation conditions defined thereon with reference to outputs of the dust sensor 30, the gas sensor 40, and the VOC sensor 50. As shown in FIG. 6, the lookup table has a number of cases of an smell level, a dust level, and a VOC level defined therein, and an operation condition defined for each of the cases.

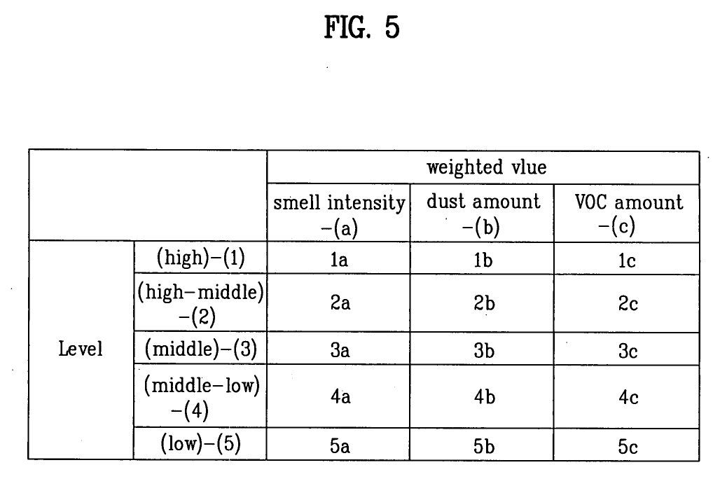

As shown in FIG. 5, the cleanliness index calculating unit 130 has a lookup table therein in which each of the smell amount, the dust amount, and the compound amount is divided into various levels (high-1/high-middle-2/middle-3/middle-small-4/small-5), and a weighted value is given to each of the smell amount, the dust amount, and the compound amount. The cleanliness index calculating unit 130 also has equation programs for calculating the cleanliness and a cleanliness index.

The display unit 90 displays the cleanliness index calculated at the cleanliness calculating unit 130 for the user.

The operation of the air conditioning system will be described.

The temperature sensor 10 and the MET sensor provide sensed values to the PMV control unit 110.

According to this, the PMV control unit 110 picks up an operation condition for the outputs of the temperature sensor 10 and the MET sensor 20 from the lookup table, and controls the fan driving unit 60, and the heater 70, accordingly.

The dust sensor 30, the gas sensor 40, and the VOC sensor 50 provide sensed values to the air cleanliness control unit 120.

According to this, the air cleanliness control unit 120 picks up an operation condition for the outputs of the dust sensor 30, the gas sensor 40, and the VOC sensor 50 from the lookup table, and controls the fan driving unit 60, and the anion generating unit 80, accordingly.

The cleanliness index calculating unit 130 picks up weighed values for the outputs of the dust sensor 30, the gas sensor 40, and the VOC sensor 50 from the lookup table respectively, and substitutes the weighted values for the cleanliness calculating equation, to calculate the cleanliness. Then, the cleanliness is substituted for the cleanliness index calculating equation, to calculate the cleanliness index, and the cleanliness index is displayed on the display unit 90.

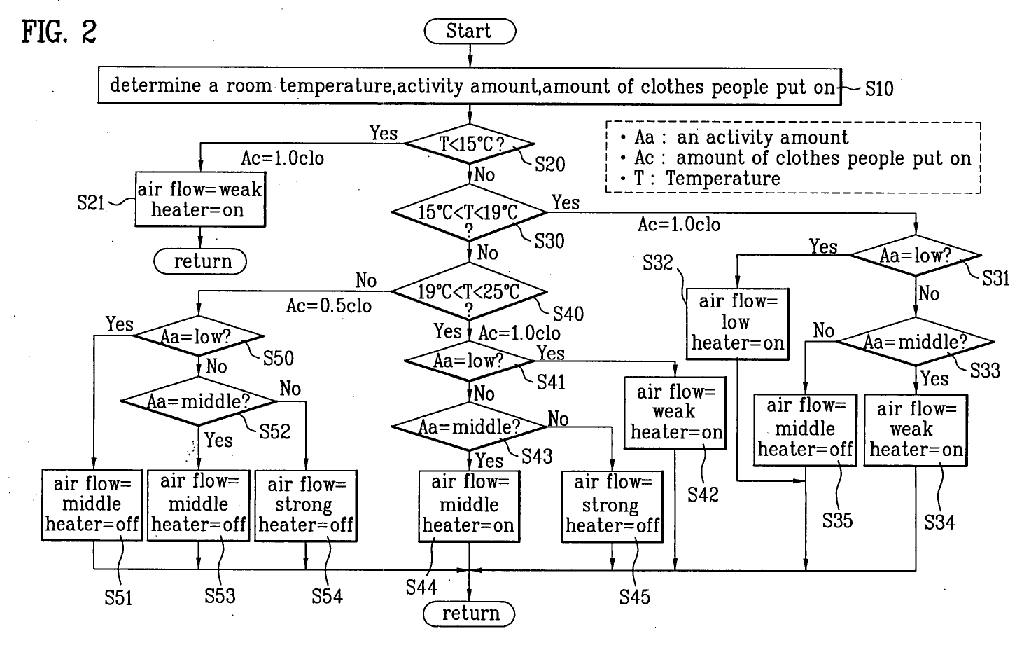

Next, a method for controlling an air conditioning system in accordance with a preferred embodiment of the present invention will be described, with reference to FIGS. 2 to 6.

First, a PMV control will be described with reference to FIGS. 2 and 3.

Referring to FIG. 2, a PMV control unit 110 determines the present room temperature, activity amount, and an amount of clothes people put on by means of a temperature sensor 10, and an MET sensor 20 (S10).

Then, the PMV control, i.e., air flow rate, and heater control, is made with reference to a lookup table as shown in FIG. 3.

That is, by dividing a range of the present room temperature into 4 steps with first to third set temperatures (for an example, 15° C., 19° C., and 25° C.), and by dividing each of the steps according to the activity amount, operation of the air flow rate and the heater is controlled according to the division where the present temperature falls on.

The activity amount is divided into high/middle/low, wherein, if the activity amount of the people in the room per a unit time period sensed at the MET sensor 20 is lower than a reference value, the activity amount is defined to be ‘low’, the activity amount is defined to be ‘middle’ if within a range of the reference value, and the activity amount is defined to be ‘high’ if higher than the reference value. The division of the activity amount and the reference value are set according to an ISO standard.

The amount of clothes people put on is set to be 1.0[clo] at a temperature below 25° C., and 0.5[clo] at a temperature higher than 25° C., with reference to an ISO standard.

The air flow rate is divided into weak, middle, and strong.

Then, the present room temperature T is determined of being below the first set temperature (for an example, 15° C.) (S20).

As a result of the determination (S20), if the present room temperature T is below the first set temperature (in this instance, the amount of clothes people put on is 1.0[clo]), the present air flow rate is set to be ‘weak’ regardless of the activity amount of the people in the room, and the heater 70 is turned on for elevating the room temperature (S21).

Since the room temperature elevation is made by using a Positive Temperature Coefficient (PTC) heater 70, stable, and accurate room temperature control is possible.

A principle of room temperature elevation by using the heater 70 will be described. A temperature to which the present room temperature is elevated is called as a set temperature (a temperature to which the room temperature is elevated by 2° C.).

Upon application of power to the heater 70, a temperature of the heater 70 rises continuously by heat generation of the heater 70 itself until the heater 70 reaches to a temperature higher than the set temperature when the heater is involved in sharp increase of an inner resistance, and decrease of current, to drop the temperature risen higher than the set temperature again, to return to the set temperature again.

If the temperature of the heater 70 keeps dropping below the set temperature, the inner resistance decreases and the current increases again, to elevate the temperature again.

Since the room temperature is maintained at the set temperature through above process, the PTC heater 70 can maintain the room temperature more securely than a general heater.

In the meantime, if the room temperature is higher than the first set temperature (15° C.), and below the second set temperature (19° C.) (the amount of clothes people put on in this instance is 1.0[clo]), the activity amount of the people in the room is determined (S30, S31).

That is, if the activity amount of the people in the room is ‘low’ or ‘middle’, the air flow rate is set to ‘weak’, and the heater 70 is turned on (S32, S33, S34), and if the activity amount of the people in the room is ‘high’, the air flow rate is set to ‘middle’, and the heater 70 is turned off (S35).

In the meantime, if the room temperature is higher than the second set temperature (19° C.), and below the third set temperature (25° C.) (the amount of clothes people put on in this instance is 1.0[clo]), the activity amount of the people in the room is determined (S40, S41).

That is, if the activity amount of the people in the room is ‘low’, the air flow rate is set to ‘weak’, and the heater 70 is turned on (S42), and if the activity amount of the people in the room is ‘middle’, the air flow rate is set to ‘middle’, and the heater 70 is turned on (S43, and S44). If the activity amount of the people in the room is ‘high’, the air flow rate is set to ‘strong’, and the heater 70 is turned off(S45).

In the meantime, if the room temperature is higher than the third set temperature (25° C.) (the amount of clothes people put on in this instance is 0.5[clo]), and the activity amount of people in the room is ‘low’ or ‘middle’, the air flow rate is set to ‘middle’ and the heater 70 is turned off (S50˜S53).

If the room temperature is higher than the third set temperature (25° C.), and the activity amount of people in the room is ‘high’, the air flow rate is set to ‘strong’ and the heater 70 is turned off (S54).

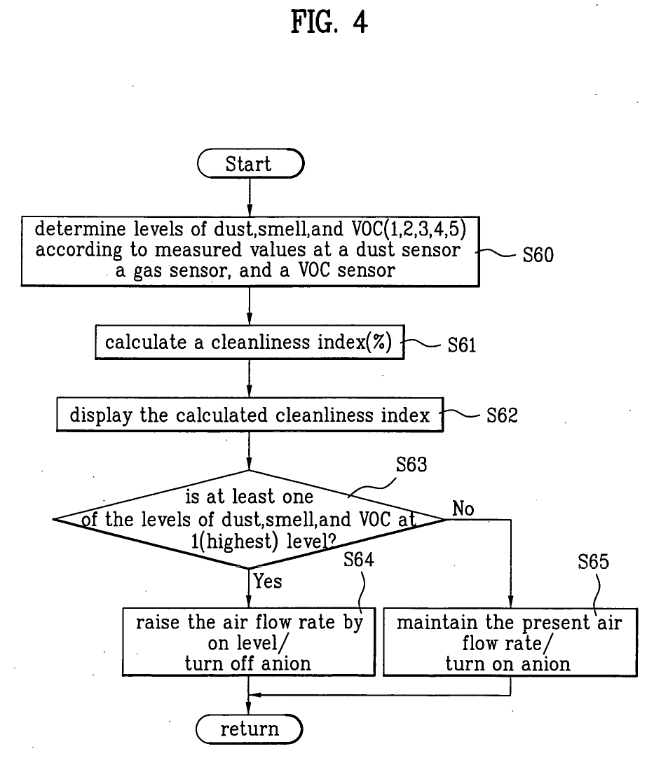

Next, an air cleaning control will be described with reference to FIGS. 4 to 6.

An air cleaning control unit 120 determines levels of the dust amount, smell intensity, and the VOC amount measured at the dust sensor 30, the gas sensor 40, and the VOC sensor 50 (S60).

As can be noted in the lookup table in FIG. 5, the smell intensity, the dust amount, and the VOC amount are determined to be as one of levels of high (1)/high-middle (2)/middle (3)/middle-low(4)/low(5) respectively, and weighted values of ‘a’ for the smell intensity, ‘b’ for the dust amount, and ‘c’ for the VOC amount are given.

The levels of (1), (2), (3), (4), and (5) meet a condition of (1)<(2)<(3)<(4)<(5), the weighted values of (a), (b), and (c) meet a condition of (a)>(b)>(c).

Then, the cleanliness index is calculated by using the levels of the determined dust amount, smell intensity, and VOC amount (S61).
Y=Σ(Sₗₑᵥₑₗ*S_{weight}+Dₗₑᵥₑₗ*D_{weight}+V_{Level}*V_{weight}) (3)

Where, S_{Level} denotes an smell level, S_{Weight} denotes the weighted value (a) of the smell intensity, D_{Level} denotes an dust level, D_{Weight} denotes the weighted value (b) of the dust amount, V_{Level} denotes a VOC level, and V_{Weight} denotes the weighted value (c) of the VOC amount.

In order to calculate the cleanliness index, it is required to calculate the cleanliness Y The cleanliness Y can be calculated according to the following equation (3).
Cleanliness index (%)=[Y/(5a+5b+5c)]*100 (4)

Accordingly, the cleanliness Y is calculated by applying the levels and the weighted values to equation (3), and the cleanliness Y calculated thus is applied to equation (4), to calculate a room cleanliness index (%).

The equation (4) denotes a percentage of the present cleanliness with respect to the lowest cleanliness (a sum of the lowest levels of smell, dust, and VOC having weighted values thereof applied thereto, respectively).

Then, the room cleanliness index (%) calculated thus, i.e., the present cleanliness state, is displayed on the display unit 90 (S62).

Then, the air flow rate of the air conditioning fan and generation of anions are controlled according to the dust level, the smell level, the VOC level determined with reference to the lookup table.

That is, when at least any one of the dust level, the smell level, and the VOC level is “high” presently, the air flow rate presently set (for an example, one that is set in the PMV control process S10˜S54) is raised by one level, and the anion generating unit 80 is turned off (S63, and S64).

For an example, in a state the present air flow rate is set to ‘low’, if at least one of the dust level, the smell level, and the VOC level is “high” presently, the air flow rate is raised by one level to set the air flow rate to ‘middle’.

For cases other than these, the present air flow rate is maintained, and the anion generating unit 80 is turned on (S65), to perform the cleaning operation.

The air conditioning system and the method for controlling the same has the following advantages.

First, room comfortability can be enhanced taking all of the activity amount of people in the room, and the amount of clothes the people put on, dust, smell, VOC, and so on into account, and a cleaning can be performed, effectively.

Second, by controlling the air conditioning system with the PMV control and the cleanliness control, the people in the room can be better comfortability.

Third, the stable room temperature control by means of a PTC heater permits to enhance comfort satisfaction of people in the room.

Fourth, the real time display of room cleanliness permits to enhance user's reliability on the product.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

1. An air conditioning system comprising:
a temperature sensor for sensing a room temperature;
an MET (metabolic) sensor for sensing an activity amount of people in a room;
a dust sensor for sensing a dust amount;
a gas sensor for sensing an intensity of smell;
a VOC (Volatile Organic Compounds) sensor for sensing a compound amount;
a fan driving unit for controlling an air flow rate;
a heater for raising a room temperature;
an anion generating unit for generating anion; and
a control unit for controlling the fan driving unit and the heater according to an operation condition preset with reference to a sensed room temperature and the activity amount of people in the room, and controlling the fan driving unit and the anion generating unit according to an operation condition preset with reference to a sensed dust amount, the intensity of smell, and the VOC amount.

2. The air conditioning system as claimed in claim 1, wherein the heater is a PTC (Positive Temperature Coefficient) heater.

3. The air conditioning system as claimed in claim 1, wherein the control unit includes;
a PMV control unit for controlling the fan driving unit and the heater according to an operation condition preset with reference to outputs of the temperature sensor and the MET sensor, and
an air cleanliness control unit for controlling the fan driving unit and the anion generating unit according to an operation condition preset with reference to outputs of the dust sensor, the gas sensor, and the VOC sensor.

4. The air conditioning system as claimed in claim 3, wherein the PMV control unit has a lookup table therein, having operation conditions defined thereon with reference to outputs of the temperature sensor and the MET sensor.

5. The air conditioning system as claimed in claim 3, wherein the air cleanliness control unit has a lookup table therein, having operation conditions defined thereon with reference to outputs of the dust sensor, the gas sensor, and the VOC sensor.

6. The air conditioning system as claimed in claim 1, wherein the control unit further includes a cleanliness calculating unit for calculating an air cleanliness index with reference to outputs of the dust sensor, the gas sensor, and the VOC sensor.

7. The air conditioning system as claimed in claim 6, wherein the control unit further includes a display unit for displaying the cleanliness index calculated at the cleanliness index calculating unit.

8. A method for controlling an air conditioning system, comprising the steps of:
sensing a room temperature, an activity amount of people in a room, a smell intensity, a dust amount, and a VOC amount;
controlling an air flow rate of an air conditioning fan, and a temperature according to an operation condition preset with reference the sensed room temperature, and the activity amount of the people in the room;
determining levels of smell, dust, and VOC with reference to the sensed smell intensity, the dust amount, and the VOC amount; and
controlling the air flow rate of the air conditioning fan, and generation of anion according to an operation condition preset with reference to the levels determined in above step.

9. The method as claimed in claim 8, wherein the step of controlling an air flow rate of an air conditioning fan, and a temperature includes the steps of;
defining temperature ranges with at least two set temperatures, defining activity amount levels for each of the temperature ranges, and picking up an operation condition for the sensed room temperature, and the activity amount of people in the room from a lookup table having operation conditions defined thereon for respective activity levels, and
controlling the air flow rate and the temperature according to the picked up operation condition.

10. The method as claimed in claim 9, wherein the at least two set temperatures are set with reference to the amount of clothes people in a room put on defined in an ISO standard.

11. The method as claimed in claim 9, wherein the activity level is set with reference to an ISO standard.

12. The method as claimed in claim 8, wherein the step of determining levels of smell, dust, and VOC includes the step of,
reading a lookup table for the sensed smell intensity, the dust amount, and the VOC amount, the lookup table having levels for at least two ranges of each of the smell intensity, the dust amount, and the VOC amount defined in pertinent units thereon.

13. The method as claimed in claim 8, wherein the step of controlling the air flow rate of the air conditioning fan, and generation of anion includes the steps of;
picking up an operation condition for levels of smell, dust, and VOC from a lookup table, the lookup table having operation conditions for cases of levels of the smell, the dust, and the VOC; and
controlling the air flow rate and the anion generation according to the operation condition picked up.

14. The method as claimed in claim 13, wherein the operation condition on the lookup table is defined to raise the air flow rate if at least any one of the levels of the smell, the dust, and the VOC is at the highest level.

15. The method as claimed in claim 13, wherein the operation condition on the lookup table is defined to generate anion if at least one of the levels of the smell, the dust, and the VOC is not at the highest level.

16. The method as claimed in claim 8, further comprising the step of calculating a cleanliness index with reference to the sensed smell intensity, the dust amount, and the VOC amount, and displaying the calculated cleanliness index.

17. The method as claimed in claim 16, wherein the step of calculating a cleanliness index includes the steps of,
summing weighted values of levels of the smell, dust, VOC determined presently, to calculated the cleanliness, and
dividing the calculated cleanliness by a sum of weighted values of the lowest levels of the smell, dust, and VOC, and converting the divided value into a percentage.

18. The method as claimed in claim 17, wherein the weighted value is defined as a smell level*‘a’, dust level*‘b’, and a VOC level*‘c’, and ‘a’, ‘b’, and ‘c’ satisfy a condition of a>b>c.
